(19) United States
(12) Patent Application Publication
(10) Pub. No.: US 2026/0187847 A1
(43) Pub. Date: Jul. 2, 2026

(54) Data Compression Method, Data Compression Circuit, Data Decompression Method, Data Decompression Circuit and Data Processing System

(71) Applicant: FITIPOWER INTEGRATED TECHNOLOGY INC., Hsinchu-City (TW)

(72) Inventors: Chi-Te Lee, Hsinchu City (TW); Yi-Ru Xie, Hsinchu City (TW); Shih-Lun Chen, Hsinchu City (TW)

(73) Assignee: FITIPOWER INTEGRATED TECHNOLOGY INC., Hsinchu-City (TW)

(21) Appl. No.: 19/004,489

(22) Filed: Dec. 30, 2024

(51) Int. Cl. G06T 9/00

(52) U.S. Cl. CPC G06T 9/00

(57) ABSTRACT

A data compression method for an original data containing a plurality of characters is provided. The data compression method includes sequentially obtaining first consecutive characters from the original data, wherein a number of characters of the first consecutive characters is a character packing number; comparing whether each character of the first consecutive characters is the same to obtain a comparison result; generating a packet in a first encoding format when the comparison result indicates that the first consecutive characters are repetitions of a repeat character, or generating the packet in a second encoding format when the comparison result indicates that the first consecutive characters comprise different characters; and outputting the packet. The packet in the first encoding format and the packet in the second encoding format have the same length.

### BACKGROUND OF THE INVENTION

### 1. Field of the Invention

The present invention relates to a data compression method, a data compression circuit, a data decompression method, a data decompression circuit and a data processing system, and more particularly, to a data compression method, a data compression circuit, a data decompression method and a data decompression circuit that take into account both highly repetitive data and non-repetitive data without loss, and a data processing system using the data compression circuit and the data decompression circuit for instant on logo display technology.

### 2. Description of the Prior Art

With the advancement of display technology, in addition to improvements in image quality and resolution, displays have also become thinner and lighter. As a result, electronic products such as computers, smartphones, wearable devices, and electronic readers are all equipped with displays. However, as the internal storage space of image transmission devices (such as graphics processing units) continues to grow larger, the time required to initialize and perform link training for DisplayPort during device startup has also increased, resulting in a longer waiting time before the image transmission device can begin sending images. In this situation, conventional technologies have proposed the Instant on Logo display technology to replace the image transmission device to output a splash screen, allowing users to quickly grasp the current status of the electronic product.

In general, the splash screen typically contains simple icons or a small amount of status text for users to quickly interpret. The splash screen is characterized by simple patterns, high repetition of pattern data and customizable content. Therefore, the electronic products need to reserve certain storage space to store the image data for the splash screen. However, due to limited storage space, the image data must be compressed as much as possible to reduce the amount of data without loss of image content.

### SUMMARY OF THE INVENTION

Therefore, the present invention aims to provide a data compression method, a data compression circuit, a data decompression method, a data decompression circuit and a data processing system that improve the data compression ratio and reduce the storage space required to store data without losing the data content.

An embodiment of the present invention discloses a data compression method for an original data containing a plurality of characters. The data compression method includes sequentially obtaining first consecutive characters from the original data, wherein a number of characters of the first consecutive characters is a character packing number; comparing whether each character of the first consecutive characters is the same to obtain a comparison result; generating a packet in a first encoding format when the comparison result indicates that the first consecutive characters are repetitions of a repeat character, or generating the packet in a second encoding format when the comparison result indicates that the first consecutive characters comprise different characters; and outputting the packet. The packet in the first encoding format and the packet in the second encoding format have the same length.

An embodiment of the present invention further discloses a data compression circuit for an original data containing a plurality of characters. The data compression circuit includes a counting control unit, a data comparing unit and a packet generating unit. The counting control unit is used to sequentially obtain first consecutive characters from the original data, wherein a number of characters of the first consecutive characters is a character packing number. The data comparing unit is coupled to the counting control unit, and used to compare whether each character of the first consecutive characters is the same to obtain a comparison result. The packet generating unit, coupled to the counting control unit and the data comparing unit, is used to generate a packet in a first encoding format when the comparison result indicates that the first consecutive characters are repetitions of a repeat character or generate the packet in a second encoding format when the comparison result indicates that the first consecutive characters comprise different characters, and output the packet. The packet in the first encoding format and the packet in the second encoding format have the same length.

An embodiment of the present invention further discloses a data decompression method. The data decompression method includes obtaining a packet from a compressed data according to a packet length, and obtaining a flag carried in the packet; analyzing the packet according to a first encoding format to generate a first decompressed data, and analyzing the packet according to a second encoding format to generate a second decompressed data; and outputting the first decompressed data or the second decompressed data according to the flag.

An embodiment of the present invention further discloses a data decompression circuit. The data decompression circuit includes a packet segmenting unit, a first format decoding unit, a second format decoding unit and a decoding selection unit. The packet segmenting unit is used to obtain a packet from a compressed data according to a packet length, and obtain a flag carried in the packet. The first format decoding unit is coupled to the packet segmenting unit and used to analyze the packet according to a first encoding format to generate a first decompressed data. The second format decoding unit is coupled to the packet segmenting unit and used to analyze the packet according to a second encoding format to generate a second decompressed data. The decoding selection unit is coupled to the packet segmenting unit, the first format decoding unit and the second format decoding unit, and is used to output the first decompressed data or the second decompressed data according to the flag.

An embodiment of the present invention further discloses a data processing system. The data processing system includes a storage unit, a storage control unit, a decompression unit and an image display control unit. The storage unit is used to store a compressed image data. The storage control unit is coupled to the storage unit and used to read the compressed image data. The decompression unit is coupled to the storage control unit, and is configured as the data decompression circuit aforementioned to decompress the compressed image data into an instant on logo image and output the instant on logo image. The image display control unit is coupled to the decompression unit and an image transmission unit, and is used to output the instant on logo image of the decompression unit or a display image of the image transmission unit to an image display unit according to a control signal of the image sending unit.

These and other objectives of the present invention will no doubt become obvious to those of ordinary skill in the art after reading the following detailed description of the preferred embodiment that is illustrated in the various FIG. s and drawings.

### BRIEF DESCRIPTION OF THE DRAWINGS

FIG. 1 is a schematic diagram of traditional run-length encoding.

FIG. 2 is a schematic diagram of different encoding formats according to an embodiment of the present invention.

FIG. 3 is a schematic diagram of a data compression circuit according to an embodiment of the present invention.

FIG. 4 is a flowchart of a data compression process according to an embodiment of the present invention.

FIG. 5 is a schematic diagram of an example for data compression according to an embodiment of the present invention.

FIG. 6 is a schematic diagram of various usages of padding data according to an embodiment of the present invention.

FIG. 7 is a schematic diagram of the padding data defining various recurrent patterns according to an embodiment of the present invention.

FIG. 8 is a schematic diagram of a data decompression circuit according to an embodiment of the present invention.

FIG. 9 is a flowchart of a data decompression process according to an embodiment of the present invention.

FIG. 10 is a schematic diagram of a data processing system according to an embodiment of the present invention.

FIG. 11 is a schematic diagram of compression examples according to an embodiment of the present invention.

FIG. 12 is a schematic diagram of a data processing system according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

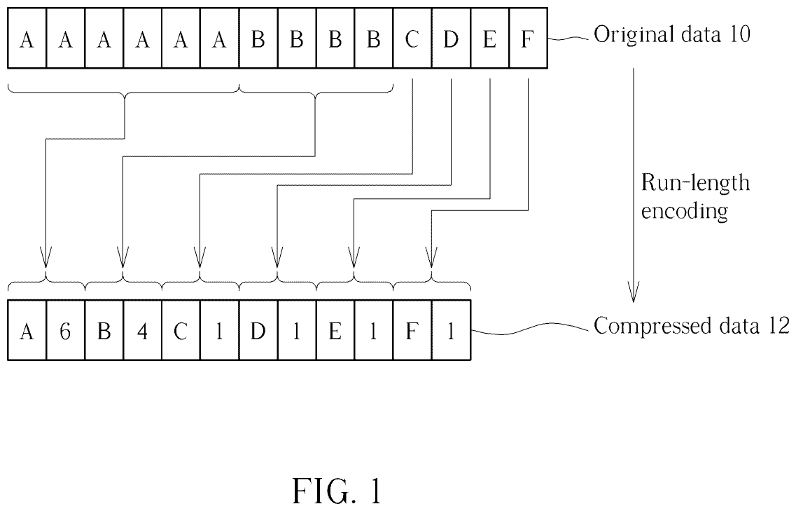

Run-length encoding (RLE) is a commonly used reversible and lossless data compression technology, which replaces the repetition of the original data with the number of consecutive occurrences of the data, having the advantages of high speed and simplicity. Please refer to FIG. 1, which is a schematic diagram of traditional run-length encoding. As shown in FIG. 1, an original data 10 comprising a plurality of characters {A, A, A, A, A, A, B, B, B, B, C, D, E, F} may be compressed into a compressed data 12 through run-length encoding. As shown in the compressed data 12, the encoding format of run-length encoding uses a pair of a character and a number to record the content of each character and the number of consecutive occurrences thereof. When the data is highly repetitive, run-length encoding may significantly reduce the amount of data. For example, the consecutive repeat characters {A, A, A, A, A, A, B, B, B, B} in the original data 10 may be encoded as {A, 6, B, 4} according to run-length encoding, greatly compressed from the original 10 characters to only 4 characters. However, when the data is low repetitive, run-length encoding may cause the compression result to be larger than the original data size. For example, the consecutive non-repeating characters {C, D, E, F} in the original data 10 may be encoded as {C, 1, D, 1, E, 1, F, 1} according to run-length encoding, where the encoded data has 8 characters, which is double the size of the original 4 characters. Therefore, there is still room for improving run-length coding.

The present invention aims to propose a data compression technique that preserves the better compression rate of run-length coding when the data is highly repetitive, and at the same time avoids the problem of data volume expansion after compression when the data is low repetitive.

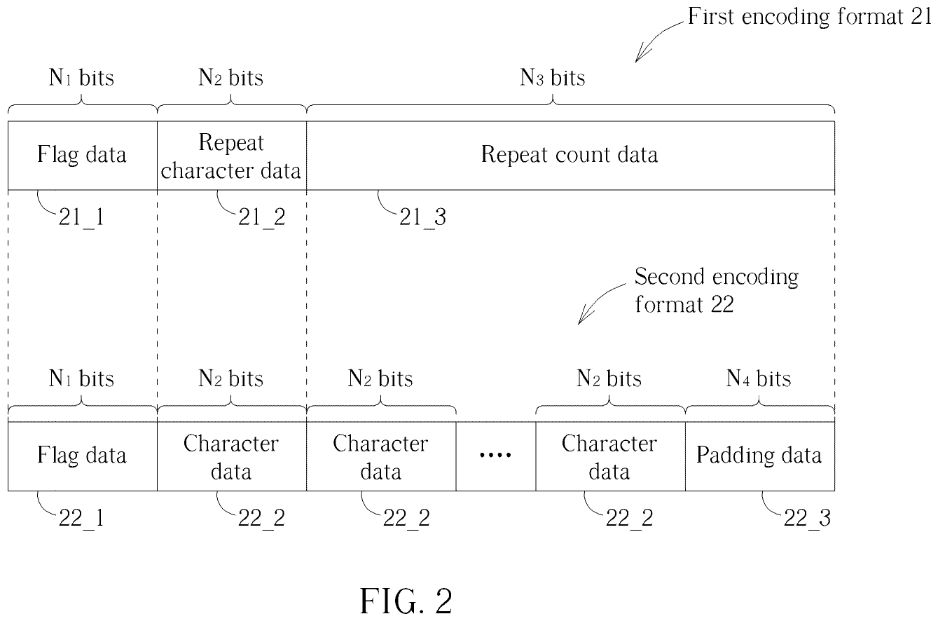

Please refer to FIG. 2, which is a schematic diagram of different encoding formats according to an embodiment of the present invention. The data compression method of the embodiment of the present invention performs data compression by encoding data according to a first encoding format 21 and a second encoding format 22; conversely, the data decompression method of the embodiment of the present invention restores the compressed data by parsing packets according to the first encoding format 21 and the second encoding format 22. In detail, the packet generated according to the first encoding format 21 is used to store repetitive data, and the packet generated according to the second encoding format 22 is used to store non-repetitive data, so that data with different characteristics may be processed according to different encoding methods. It should be noted that, in the embodiments of the present invention, repetitive data refers to consecutive characters consisting of the continuous repetition of a single character (e.g., {A, A, A}, {A, A, . . . , A}), while non-repetitive data refers to consecutive characters containing different characters, including completely different characters (e.g., {A, B, C}, {A, B, C, D}) and partially the same characters (e.g., {A, A, B}, {A, B, B}, {A, B, A}, {A, A, . . . , B}).

As shown in FIG. 2, the first encoding format 21 comprises a flag data 21_1, a repeat character data 21_2 and a repeat count data 21_3. The flag data 21_1 comprises a flag, and the flag is used to indicate that a packet is generated based on the first encoding format 21. In the embodiment, the flag may be set to 1, but is not limited thereto. Assuming that the length of the flag data 21_1 is N₁ bits, then N₁ may be a positive integer greater than or equal to 1. The repeat character data 21_2 is used to indicate a repeat character. Assuming that the length of the repeat character data 21_2 is N₂ bits, then N₂ is equal to the size of a character, which is used to store a repeat character mentioned above. N₂ may be 1, 2, 3, 4, or other positive integer. The repeat count data 21_3 is used to indicate a repeat count of the repeat character. Assuming that the length of the repeat count data 21_3 is N₃ bits, then the maximum of the repeat count that may be stored in the repeat count data 21_3 is 2^{N}^{₃}−1. N₃ may be a positive integer greater than or equal to 2. When the repeat count of a character exceeds 2^{N}^{₃}−1, at least one additional packet should be generated according to the first encoding format 21 or the second encoding format 22 for storage. Accordingly, when performing compression encoding, the repeat character that appears consecutively may be wrapped into one or more packets, significantly compressing the amount of data and thereby reducing the storage space required.

The second encoding format 22 comprises a flag data 22_1, a plurality of character data 22_2 and a padding data 22_3. The flag data 22_1 comprises a flag, and the flag is used to indicate that a packet is generated based on the second encoding format 22. In the embodiment, the flag may be set to 0, but is not limited thereto. The length of the flag data 22_1 is N₁ bits and needs to have the same length as the flag data 21_1 of the first encoding format 21. The plurality of character data 22_2 is used to indicate a group of consecutive characters. Assuming that the plurality of character data 22_2 comprises M characters, then M may be a positive integer greater than or equal to 2. The length of each character of the plurality of character data 22_2 is N₂ and needs to have the same length as the repeat character data 21_2 of the first encoding format 21. The padding data 22_3 is used to complement the length of the packet or to carry specific coding information. Assuming that the length of the padding data 22_3 is N₄ bits, then N₄ is an integer greater than or equal to 0. In an embodiment, the sum of the length N₁ of the flag data 22_1 and the length N₄ of the padding data 22_3 is equal to the length N₂ of the repeat character data 21_2 (in bit). Accordingly, when performing compression encoding, consecutive characters that are not exactly repetitions of a same character may be wrapped into a packet, improving the problem of data volume expansion for non-repetitive data in run-length encoding. In the embodiment of the present invention, although the packet in the second encoding format 22 is used to store non-repetitive data, it can also be used to store repetitive data under certain circumstances (as described later); unlike the second encoding format 22, the first encoding format 21 is only applicable to store repetitive data.

Note that, in the embodiment of the present invention, the packets generated according to the first encoding format 21 and the second encoding format 22 should have the same packet length S, that is to say, the following conditions need to be met:

$$S = {N}_{1} + {N}_{2} + {N}_{3} = {N}_{1} + M \times {N}_{2} + {N}_{4}$$

where N₁ represents the length of the flag data 21_1 of the first encoding format 21, N₂ represents the length of the repeat character data 21_2, and N₃ represents the length of the repeat count data 21_3. That is to say, N₁+N₂+N₃ represents the packet length of the first encoding format 21. Additionally, N₁ also represents the length of the flag data 22_1 of the second encoding format 22, N₂ also represents the length of each character data in the plurality of character data 22_2, and M represents the number of character data in the plurality of character data 22_2 (i.e., the maximum number of characters that may be packaged in the packet of the second encoding format 22, hereinafter referred to as the “character packing number”), and N₄ represents the length of the padding data 22_3. That is to say, N₁+M×N₂+N₄ represents the packet length of the second encoding format 22. Each of the above parameters of the first encoding format 21 and the second encoding format 22 may be determined according to actual application requirements (for example: data compression rate, hardware/software co-design and complexity, suitable character length, packet length).

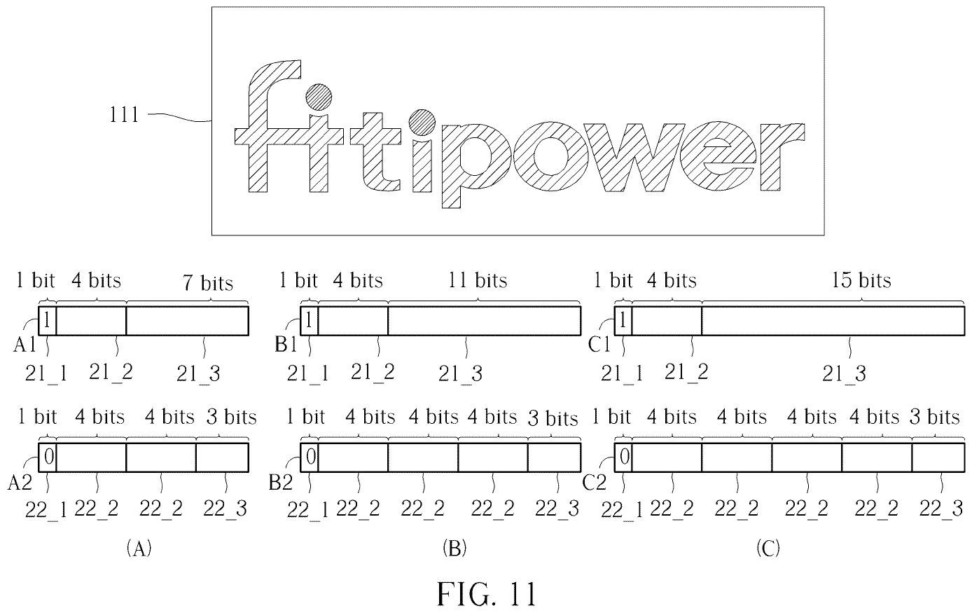

For example, please refer to FIG. 11, which is a schematic diagram of compression examples according to an embodiment of the present invention, including three cases (A), (B), and (C) with different packet lengths S. The case (A) compresses the data using a packet A1 in the first encoding format 21 and a packet A2 in the second encoding format 22. The length of the flag data N₁ is 1, the length of the character data N₂ is 4, the length of the repeat count data N₃ is 7, the length of the padding data N₄ is 3, and the character packing number M is 2. The length of the packet A1 is calculated as N₁+N₂+N₃=1+4+7=12 (bits); the length of the packet A2 is calculated as N₁+M×N₂+N₄=1+2×4+3=12 (bits); that is to say, the length S of the packets used in the case (A) is 12 bits. The case (B) compresses the data using a packet B1 in the first encoding format 21 and a packet B2 in the second encoding format 22. The length of the flag data N₁ is 1, the length of the character data N₂ is 4, the length of the repeat count data N₃ is 11, the length of the padding data N₄ is 3, and the character packing number M is 3. The length of the packet B1 is calculated as N₁+N₂+N₃=1+4+11=16 (bits); the length of the packet B2 is calculated as N₁+M×N₂+N₄=1+3×4+3=16 (bits); that is to say, the length S of the packets used in the case (B) is 16 bits. Similarly, the case (C) compresses the data using a packet C1 in the first encoding format 21 and a packet C2 in the second encoding format 22. The length of the flag data N₁ is 1, the length of the character data N₂ is 4, the length of the repeat count data N₃ is 15, the length of the padding data N₄ is 3, and the character packing number M is 4. The length of the packet C1 is calculated as N₁+N₂+N₃=1+4+15=20 (bits); the length of the packet C2 is calculated as N₁+M×N₂+N₄=1+4×4+3=20 (bits); that is to say, the length S of the packets used in the case (C) is 20 bits. In other words, the lengths N₁, N₂, N₃, N₄ of the fields of the packets and the character packing number M may be determined according to the actual application requirements, provided that the packets generated by the first encoding format 21 and the second encoding format 22 have the same length.

In should be noted, the length of the character data N₂ may be the unit length of the data in the original data, but not limited to it. When determining the length of the character data N₂, the type of the original data should be considered. For example, when the original data is an image with 4-bit color depth, the length of the character data N₂ may be 4, and when the original data is an image with 8-bit color depth, the length of the character data N₂ may be 8. The length of the character data N₂ may be adjusted according to the actual requirements to achieve optimized compression effect. In addition, the length of the repeat count data N₃ is related to the occurrence of repetitive data in the original data (i.e., the maximum number of repetitions of characters that may be recorded in a packet), and the character packing number M is related to the occurrence of non-repetitive data (i.e., the number of characters that may be recorded in a packet), which should be weighed against the characteristics of the contents of the original data in order to achieve the optimal configuration. For example, when the original data contains a large number of consecutive repeat characters, the repeat count data length N₃ may be increased to achieve a better compression rate. In an embodiment, depending on the hardware characteristics, the packet length S may be a multiple of 4 for better processing performance, but is not limited thereto. In short, in the embodiment of the present invention, the length of the character data N₂ may be determined according to the type of the original data, then the length of the repeat count data N₃ and the character packing number M may be weighed according to the characteristics of the original data, and finally, the padding data N₄ may be used to supplement the packet length of the second encoding format 22 to be the same as the packet length of the first encoding format 21. In addition, the order of the flag data 21_1, the repeat character data 21_2 and the repeat count data 21_3 in the first encoding format 21, and the order of the flag data 22_1, the plurality of character data 22_2 and the padding data 22_3 in the second encoding format 22 may be adjusted according to the actual requirements, provided that the flag data 21_1 of the first encoding format 21 and the flag data 22_1 of the second encoding format 22 are arranged in the same position of the packets.

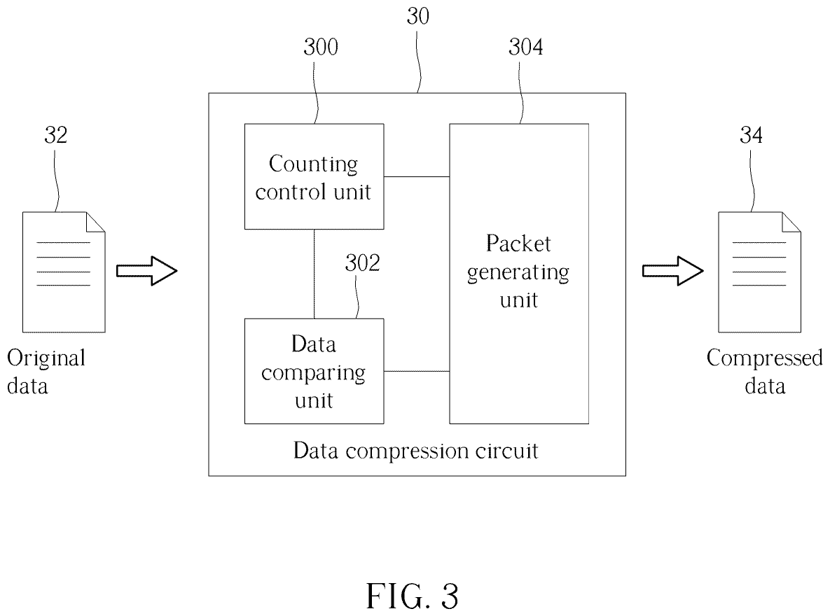

Please refer to FIG. 3, which is a schematic diagram of a data compression circuit 30 according to an embodiment of the present invention. The data compression circuit 30 may be used to compress an original data 32 and then output as a compressed data 34. The data compression circuit 30 comprises a counting control unit 300, a data comparing unit 302, and a packet generating unit 304.

The counting control unit 300 is coupled to the data comparing unit 302 and the packet generating unit 304, and is used to count the number of data of the original data 32 that have been input and that have not been processed. The counting control unit 300 is also used to control the number of characters of the original data 32 input to the data comparing unit 302 and to receive data comparison results from the data comparing unit 302, thereby calculating a repeat count of the consecutive repeat characters. On the other hand, the counting control unit 300 is used to provide the repeat count to the packet generating unit 304 and control the packet generating unit 304. The counting control unit 300, in addition to instructing the packet generating unit 304 on the timing for generating packets, also instructs whether to use the first encoding format 21 or the second encoding format 22 for generating packets.

The data comparing unit 302 is coupled to the counting control unit 300 and the packet generating unit 304 and used for comparing characters and determining whether the characters are the same. The data comparing unit 302 receives characters from the counting control unit 300 and returns the comparison results to the counting control unit 300. In addition, the data comparing unit 302 stores the characters temporarily and outputs the characters to the packet generating unit 304.

The packet generating unit 304 is coupled to the counting control unit 300 and the data comparing unit 302 and is used for generating packets. The packet generating unit 304 temporarily stores the characters input by the data comparing unit 302, and generates packets in the first encoding format 21 or the second encoding format 22 according to instructions from the counting control unit 300. Accordingly, the data compression circuit 30 converts the original data 32 into the compressed data 34 composed of at least one packet. In other words, the compressed data 34 is composed of one or more packets generated according to the first encoding format 21 or the second encoding format 22.

In an embodiment, the data compression circuit 30 may additionally comprise a storage unit (not shown in FIG. 3). The storage unit is coupled to the packet generating unit 304 for storing the compressed data 34, and the packet generating unit 304 may output and store the packets to the storage unit. In another embodiment, the storage unit may be deployed outside the data compression circuit 30. The storage unit (not shown in FIG. 3) is used to receive packets output by the packet generating unit 304 and stores the packets as the compressed data 34.

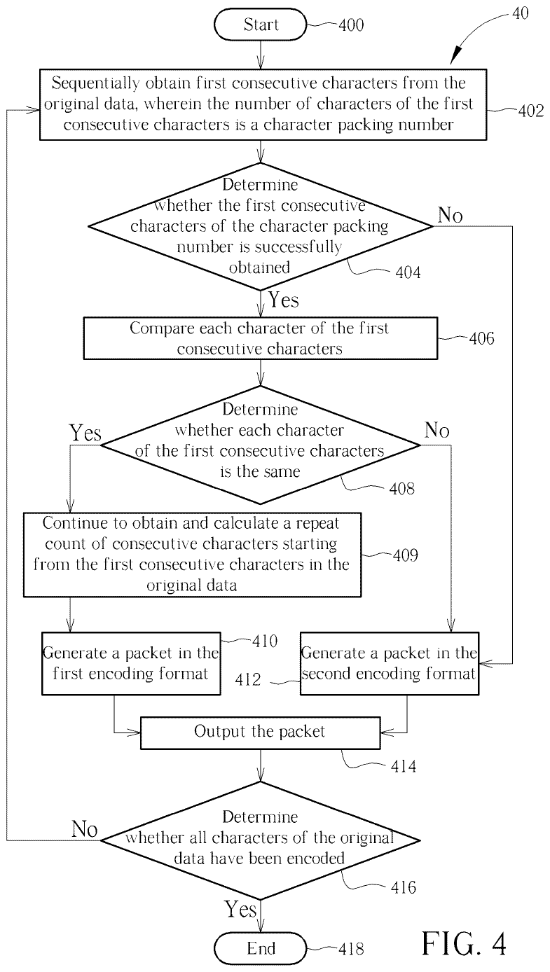

Please refer to FIG. 4, which is a flowchart of a data compression process 40 according to an embodiment of the present invention. For illustrative purposes, the data compression process 40 is described below in conjunction with the data compression circuit 30 of FIG. 3. However, it should be understood that the data compression process 40 may be executed by the data compression circuit 30, but is not limited thereto. According to the data compression process 40, the data compression circuit 30 may compress the original data 32 and then output as the compressed data 34. The original data 32 comprises a plurality of characters, which may be but is not limited to an image data. The data compression process 40 comprises the following steps:

Step 400: Start.

Step 402: Sequentially obtain first consecutive characters from the original data 32, wherein the number of characters of the first consecutive characters is a character packing number M.

Step 404: Determine whether the first consecutive characters of the character packing number M is successfully obtained. If yes, proceed to Step 406; otherwise, proceed to Step 412.

Step 406: Compare each character of the first consecutive characters.

Step 408: Determine whether each character of the first consecutive characters is the same. If yes, proceed to Step 409; otherwise, proceed to Step 412.

Step 409: Continue to obtain and calculate a repeat count of consecutive characters starting from the first consecutive characters in the original data 32, and proceed to Step 410.

Step 410: Generate a packet in the first encoding format 21.

Step 412: Generate a packet in the second encoding format 22.

Step 414: Output the packet.

Step 416: Determine whether all characters of the original data 32 have been encoded. If yes, proceed to Step 402; otherwise, proceed to Step 418.

### Step 418: End.

It should be noted that, for ease of understanding, the data compression process 40 only illustrates the steps necessary to realize the embodiments of the present invention, and does not illustrate all of the details such as boundary conditions. Those with ordinary knowledge in the art may appropriately modify and alter details such as file reading and writing, character comparison, counting, and iteration according to needs.

The steps of the data compression process 40 are described in detail below. In Step 400, the data compression circuit 30 begins data compression of the original data 32, which may comprise performing initialization settings of the data compression circuit 30. The initialization settings may comprise and is not limited to setting the parameters of the first encoding format 21 and the second encoding format 22, such as the length of the flag data N₁, the length of the character data N₂, the length of the repeat count data N₃, the length of the padding data N₄, and the character packing number M.

In Step 402, the counting control unit 300 sequentially obtains the first consecutive characters from the original data 32, where the number of characters of the first consecutive characters is a character packing number. Specifically, the character packing number M is the number of character data of the plurality of character data 22_2 in the second encoding format 22. That is to say, the first consecutive characters comprise M characters. The data compression circuit 30 obtains the first consecutive characters based on the character packing number M, and determines the applicable compression format (the first encoding format 21 or the second encoding format 22) based on the first consecutive characters in subsequent steps. For example, assuming that the character packing number M is 3, the first consecutive characters may be consecutive characters with a number of characters of 3 such as {A, A, A}, {A, A, B}, {A, B, B}, {A, B, A}.

In Step 404, when the number of the obtained first consecutive characters is fewer than the character packing number M (which means that the file has been read to the end, and therefore only characters fewer than the character packing number M are left to be encoded), the counting control unit 300 instructs the packet generating unit 304 to encode the first consecutive characters into a packet of the second encoding format 22. For example, assuming that the character packing number M is 3, the second encoding format 22 is determined to be used for encoding when only 1 or 2 characters remain to be processed. On the other hand, when the number of the obtained first consecutive characters is equal to the character packing number M, it is further determined that the first encoding format 21 or the second encoding format 22 should be used to generate the packet.

In Step 406, the data comparing unit 302 compares each character of the first consecutive characters to obtain a comparison result. Specifically, the counting control unit 300 transmits data to the data comparing unit 302 character by character. The data comparing unit 302 compares whether the newly entered character is the same as the previously entered temporary character and sends the comparison result back to the counting control unit 300.

In Step 408, the counting control unit 300 determines whether the first encoding format 21 or the second encoding format 22 is required to generate the packet according to the comparison results returned by the data comparing unit 302. When the comparison result indicates that the first consecutive characters are all repetitions of a repeat character (i.e., all characters are the same), the counting control unit 300 determines to use the first encoding format 21 to generate the packet and proceeds to Step 409; otherwise, the counting control unit 300 determines to use the second encoding format 22 to generate the packet and instructs the packet generating unit 304 to generate the packet according to the second encoding format 22 in Step 412. Specifically, the counting control unit 300 may determine whether the first consecutive characters are all repetitions of the same repeat character based on the comparison results returned by the data comparing unit 302. For example, the counting control unit 300 sequentially transmits each character of the first consecutive characters to the data comparing unit 302, sequentially obtains the comparison result of each character with the previous character, and accordingly determines whether the first consecutive characters are all repetitions of the same repeat character. In addition, the counting control unit 300 may calculate the number of character repetitions (namely, a repeat count) according to the comparison results returned by the data comparing unit 302, and use the repeat count as a basis for generating the packet of the first encoding format 21. For example, assuming the character packing number M is 3, when the first consecutive characters consists of same characters, such as {A, A, A}, {B, B, B}, the counting control unit 300 determines to use the first encoding format 21 to generate the packet; when the first consecutive characters comprise different characters, such as {A, A, B}, {A, B, A}, {B, A, A}, {A, B, C}, the counting control unit 300 determines to use the second encoding format 22 to generate the packet.

In Step 409, the counting control unit 300 continues to obtain and calculate the repeat count of the consecutive characters starting from the first consecutive characters in the original data 32. In detail, when determining to use the first encoding format 21 to generate the packet according to the first consecutive characters, the counting control unit 300 needs to obtain the number of consecutive repetitions (namely, the repeat count) of the repeat character in the original data 32. Specifically, the counting control unit 300 continuously obtains the character from the original data 32 and transmits the character to the data comparing unit 302 for comparison, and calculates the repeat count of the character according to the comparison results returned by the data comparing unit 302. The process of calculating the repeat count continues until the comparison result indicates that the new entered character is a different character or the repeat count is greater than or equal to the maximum of the repeat count 2^{N}^{₃}−1 that may be stored. For example, assuming that the character packing number M is 3, when the first consecutive characters consist of same characters such as {A, A, A}, the counting control unit 300 has to continue to count the actual number of repetitions of the repeat character “A”. For example, if the consecutive characters in the original data 32 starting with the first consecutive characters {A, A, A}(including the first consecutive characters {A, A, A}) may be {A, A, A, A, A, A, A, A, B, A}, the repeat count of the repeat character “A” is 7 (i.e., 8 consecutive same characters “A”).

In Step 410, the packet generating unit 304 generates the packet according to the first encoding format 21. Specifically, the counting control unit 300 obtains the repeat count of the repeat character among the consecutive characters starting with the first consecutive characters in Step 409 and transmits the repeat count to the packet generating unit 304, and the data comparing unit 302 transmits the character stored temporarily to the packet generating unit 304. The packet generating unit 304 generates the packet of the first encoding format 21 based on the repeat character (i.e., the character stored temporarily) from the data comparing unit 302 and the repeat count of the repeat character from the counting control unit 300. In detail, the flag data 21_1 of the packet may be determined as the flag (e.g., 1) of the first encoding format 21, the repeat character data 21_2 may be determined as the repeat character, and the repeat count data 21_3 may be determined as the repeat count. It should be noted that the repeat count must be limited to 2^{N}^{₃}−1. When the repeat count is out of range, return to Step 402 to prepare for generating the next packet.

In Step 412, the packet generating unit 304 generates the packet according to the second encoding format 22. Specifically, the packet generating unit 304 may set the padding data 22_3 of the packet to dummy bits, and generate the packet of the second encoding format 22 based on the first consecutive characters. In detail, the flag data 22_1 of the packet may be determined to be the flag of the second encoding format 22 (e.g., 0), the plurality of character data 22_2 may be determined to be the first consecutive character, and the padding data 22_3 may be determined to be dummy bits (e.g., all filled with 0).

In Step 414, the packet generating unit 304 outputs the packet. In an embodiment, the packet generating unit 304 may output the generated packets to the storage unit and store the packets as the compressed data 34, but is not limited thereto. The storage unit may be located inside or outside the data compression circuit 30.

Finally, in Step 416, the counting control unit 300 determines whether all the characters of the original data 32 have been encoded. If not, return to Step 402 to generate the next packet; if yes, the compression of the original data 32 is completed in Step 418.

Accordingly, the data compression circuit 30 may compress the original data 32 according to the data compression process 40 and then output the compressed data 34 composed of packets.

It should be noted, in the above embodiments, the data compression circuit 30 uses a first encoding format 21 to store repetitive data and uses the second encoding format 22 to store non-repetitive data. However, in certain circumstances, the second encoding format 22 is also applicable to store repetitive data. In an embodiment, in Step 409, when the repeat count of the repeat character is M−1 (there are M consecutive identical characters), the counting control unit 300 may instruct the packet generating unit 304 to generate the packet based on the second encoding format 22. In other words, in this case, the data compression circuit 30 may encode the first consecutive characters into the packet of the first encoding format 21 or the second encoding format 22. For example, assuming that the character packing number M is 3, when the first consecutive characters consist of identical characters such as {A, A, A}, the counting control unit 300 needs to count the actual number of repetitions of the repeat character “A”. If the consecutive characters in the original data 32 starting with the first consecutive characters (including the first consecutive characters) are {A, A, A, B, A, B, A, A, B, A}, the repeat count of the repeat character “A” is 2 (3 consecutive “A”). In this case, the counting control unit 300 may encode the first consecutive characters {A, A, A} according to the first encoding format 21 or the second encoding format 22.

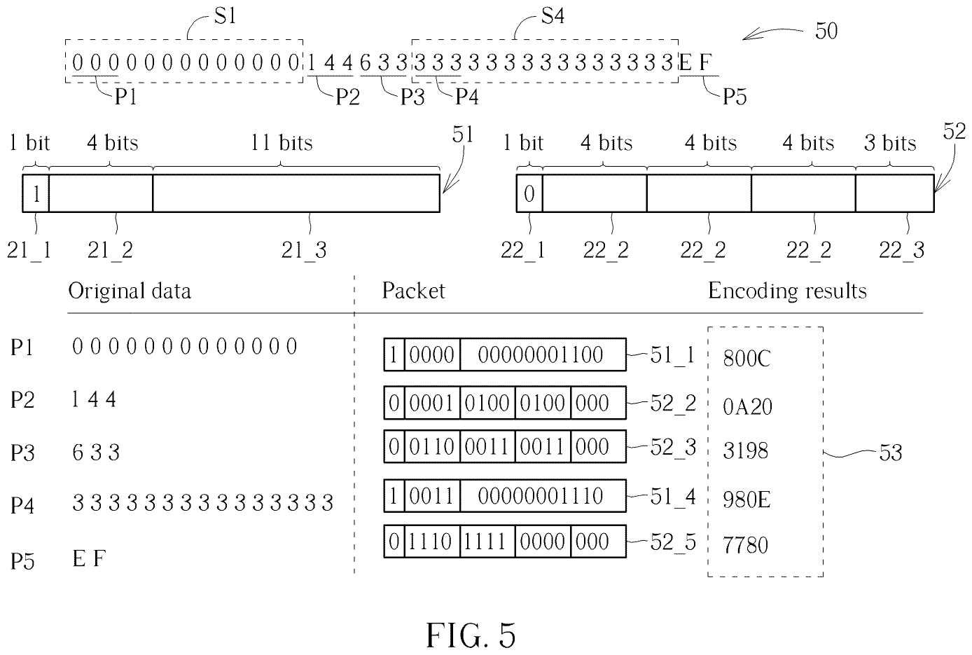

Please refer to FIG. 5, which is a schematic diagram of an example for data compression according to an embodiment of the present invention. According to the data compression process 40, the data compression circuit 30 may compress an original data 50 (comprising a plurality of characters in hexadecimal representation) into a compressed data 53. In the embodiment, a character is 4 bits, the character packing number M is 3, and a packet length is 16 bits. As shown in FIG. 5, a packet 51 in the first encoding format 21 comprises the flag data 21_1 (1 bit), the repeat character data 21_2 (4 bits), and the repeat count data 21_3 (11 bits), with the flag being set to 1. A packet 52 in the second encoding format 22 comprises the flag data 22_1 (1 bit), the three character data 22_2 (4 bits each), and the padding data 22_3 (3 bits). The flag of the package 52 is set to 0 and the padding data 22_3 may be set as dummy bits “000”.

According to the data compression process 40, the data compression circuit 30 firstly obtains first consecutive characters P1 (“000”) from the original data 50 (Step 402). The data compression circuit 30 determines that each character of the first consecutive characters P1 is “0” (Step 408), and therefore decides to generate a packet 51_1 according to the first encoding format 21. Note that, the data compression circuit 30 have to continue obtaining the consecutive repeating characters S1 in the original data 50 starting with the first consecutive characters P1, and calculate the repeat count of the repeat character “0” in the consecutive repeating characters S1 as 12 (Step 409), so as to generate the packet 51_1 (Step 410) and then output the packet (Step 414).

After encoding the consecutive repeating character S1, the data compression circuit 30 then obtains first consecutive characters P2 (“144”) (return to Step 402). The data compression circuit 30 determines that the first consecutive characters P2 contains different characters (Step 408), and therefore determines to generate a packet 52_2 (Step 412) according to the second encoding format 22 and then output the packet 52_2 (Step 414). Specifically, the three character data of the packet 52_2 are used to store the characters “1”, “4” and “4” respectively. Similarly, after the encoding of the consecutive characters P2, the data compression circuit 30 obtains first consecutive characters P3 (“633”). The first consecutive characters P3 contain different characters, and therefore the data compression circuit 30 generates a packet 52_3 according to the second encoding format 22.

After encoding the consecutive characters P3, the data compression circuit 30 obtains first consecutive characters P4 (“333”). Since each character of the first consecutive characters P4 is “3”, the data compression circuit 30 generates a packet 51_4 according to the first encoding format 21. Similar to the consecutive repeating character S1, the data compression circuit 30 obtains the consecutive repeating characters S4 in the original data 50 starting with the first consecutive characters P4, and calculates the repeat count of the repeat character “3” in the consecutive repeating characters S4 as 14, so as to generate the packet 51_4 and then output the packet. It should be noted, there is a consecutive repetition of the character “3” between the first consecutive characters P3 and P4, however, in the embodiment, it is necessary to encode all of the characters of the first consecutive characters P3 into a packet based on the character packing number M (in this example, 3 character data) and recalculate the repeat count of the character “3” starting from the first consecutive characters P4.

Finally, the data compression circuit 30 obtains first consecutive characters P5 (“EF”). The first consecutive characters P5 contains only 2 characters, which is fewer than the character packing number M (in this example, 3 character data) (Step 404), and therefore the data compression circuit 30 generates a packet 52_5 directly based on the second encoding format 22. Accordingly, the data compression circuit 30 compresses the original data 50 of 144 bits (36 characters) into the compressed data 53 of 80 bits (20 characters) with a compression rate of about 55.6%.

As can be seen from the data compression example in FIG. 5, the data encoding method according to the present invention differs from conventional run-length encoding in handling repetitive data. In detail, the run-length encoding uses a pair of a character and a number to recode the character and the number of consecutive occurrences of the character, so that even if a non-repetitive character occurs only once, the run-length encoding encodes the non-repetitive character with the number of occurrences of the character. In contrast, the data compression process 40 has a number threshold for determining the data is repetitive data or not, which is the character packing number M in the embodiment of the present invention. Taking the first consecutive characters P2 in FIG. 5 as an example, the first consecutive characters P2 (“144”) is encoded as {1, 1, 4, 2}according to the conventional run-length encoding, which represents one occurrence of the character “1” and two occurrences of the character “4”. In contrast, in this embodiment, the number of consecutive occurrences of the character “4” is fewer than the character packing number M (in this example, 3), and therefore the character “4” which occurs only twice consecutively and the character “1” that is adjacent thereto will be determined as non-repetitive data and encoded according to the second encoding format 22.

In the above embodiments, the padding data 22_3 of the second encoding format 22 is set as dummy bits to complement the number of bits of the packet so that the packets generated in the first encoding format 21 and the second encoding format 22 have the same length. However, the padding data 22_3 of the second encoding format 22 may also be used for other user-defined functions.

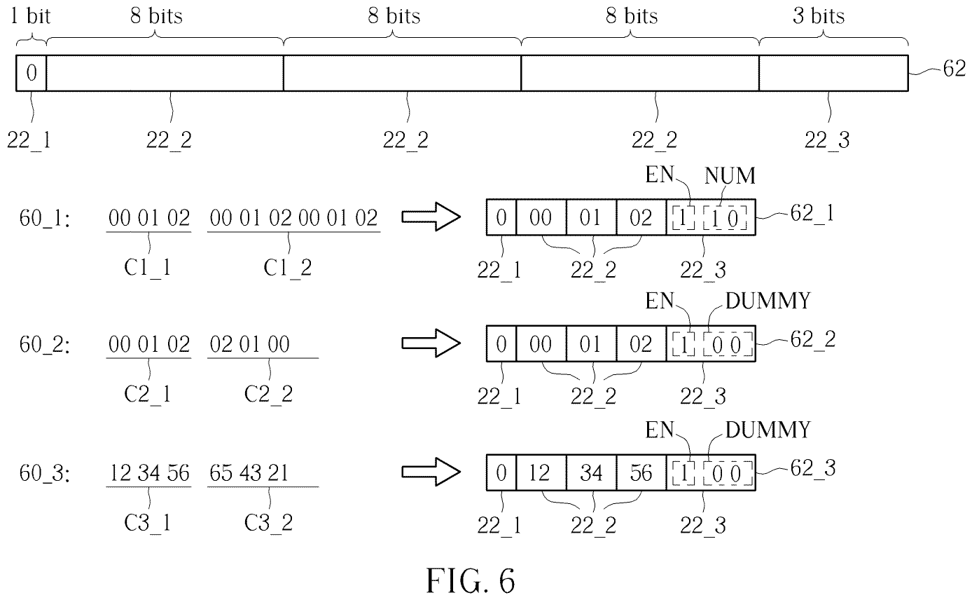

Please refer to FIG. 6, which is a schematic diagram of various usages of the padding data 22_3 according to an embodiment of the present invention. In this embodiment, the length of the flag data N₁ of the second encoding format 22 is 1, the length of the character data N₂ is 8, the length of the padding data N₄ is 3, and the character packing number M is 3, so that the packet length S is 28 (bits). As shown in FIG. 6, a packet 62 of the second encoding format 22 comprises the flag data 22_1 (1 bit), the three character data 22_2 (8 bits each, the contents thereof are illustrated in hexadecimal), and the padding data 22_3 (3 bits, the contents thereof are illustrated in binary). The flag of the packet 62 is set to 0, and the padding data 22_3 may be used to indicate different data recurrent patterns.

In an embodiment, the padding data 22_3 may be used to indicate a recurrent or non-recurrent characteristic of the data. For example, an original data 60_1 sequentially contains first consecutive characters C1_1 (“00 01 02”) and second consecutive characters C1_2 (“00 01 02 00 01 02”), where the second consecutive characters C1_2 is a double cycle of the first consecutive characters C1_1. In the embodiment, the padding data 22_3 may be divided into an enabling bit EN of 1-bit length and a recurrent count data NUM of 2-bit length. Accordingly the data compression circuit 30 may generate a packet 62_1 of the second encoding format 22 according to the first consecutive characters C1_1 and the recurrent count of 2. Specifically, the three character data 22_2 are used to indicate the first consecutive characters C1_1 respectively. The enabling bit EN of the padding data 22_3 may be, and is not limited to be, marked with “1” to indicate that the data is recurrent (marked with “0” to indicate that the data is non-recurrent). The recurrent count data NUM may be filled with the recurrent count of 2 (illustrated as “10” in binary).

In another embodiment, the padding data 22_3 may be used to indicate an inversion characteristic of the data. For example, an original data 60_2 sequentially contains first consecutive characters C2_1 (“00 01 02”) and second consecutive characters C2_2 (“02 01 00”), where the second consecutive characters C2_2 is an inversion of the first consecutive characters C2_1. In the embodiment, the padding data 22_3 may comprise an enabling bit EN of 1-bit length to indicate the inversion of the data. Accordingly the data compression circuit 30 may generate a packet 62_2 of the second encoding format 22 according to the first consecutive characters C2_1. Specifically, the three character data 22_2 are used to indicate the first consecutive characters C2_1 respectively. The enabling bit EN of the padding data 22_3 may be, and is not limited to be, marked with “1” to indicate that the data is inverted (marked with “0” to indicate that the data is not inverted). The padding data 22_3 may further comprise dummy bits DUMMY (in this example, 2 bits, illustrated as “00” in binary).

In another embodiment, the padding data 22_3 may be used to indicate a mirroring characteristic of the data. For example, an original data 60_3 sequentially contains first consecutive characters C3_1 (“12 34 56”) and second consecutive characters C3_2 (“65 43 21”), where the second consecutive characters C3_2 is an mirror of the first consecutive characters C3_1. In the embodiment, the padding data 22_3 may comprise an enabling bit EN of 1-bit length to indicate the mirroring of the data. Accordingly the data compression circuit 30 may generate a packet 62_3 of the second encoding format 22 according to the first consecutive characters C3_1. Specifically, the three character data 22_2 are used to indicate the first consecutive characters C3_1 respectively. The enabling bit EN of the padding data 22_3 may be, and is not limited to be, marked with “1” to indicate that the data is mirroring (marked with “0” to indicate that the data is not mirroring). The padding data 22_3 may further comprise dummy bits DUMMY (in this example, 2 bits, illustrated as “00” in binary).

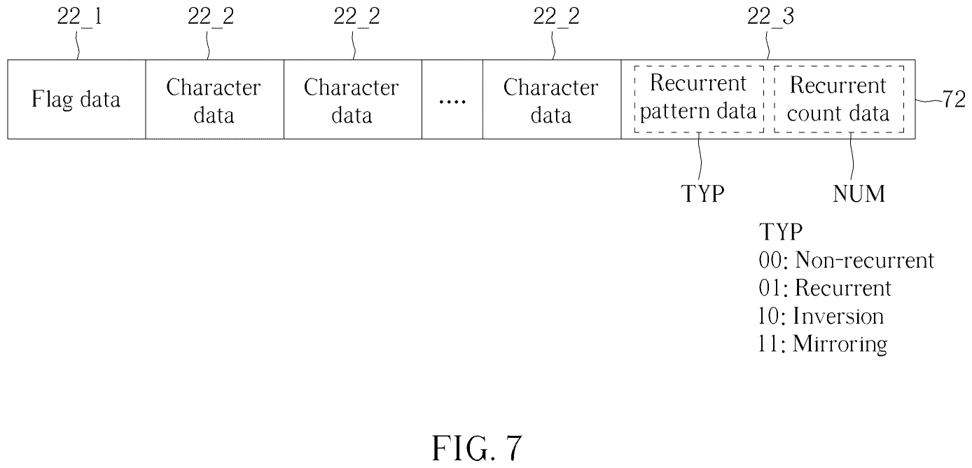

In another embodiment, the padding data 22_3 may be used to define various recurrent patterns. Please refer to FIG. 7, which is a schematic diagram of the padding data defining the various recurrent patterns according to an embodiment of the present invention. This embodiment is particularly applicable to the original data with specific data recurrent patterns. As shown in FIG. 7, a packet 72 of the second encoding format 22 comprises the flag data 22_1, the plurality of character data 22_2, and the padding data 22_3, where the padding data 22_3 further comprises a recurrent pattern data TYP and a recurrent count data NUM. The recurrent pattern data TYP is used to indicate a recurrent pattern of the first consecutive characters, and the recurrent pattern comprises the aforementioned recurrent, non-recurrent, inversion, and mirroring information for the first consecutive characters. The recurrent count data is used to indicate a recurrent count of the first consecutive characters.

In this embodiment, the step of the data compression circuit 30 generating the packet in the second encoding format 22 further comprises: the counting control unit 300 obtains second consecutive characters following the first consecutive characters in the original data; the data comparing unit 302 determines a recurrent pattern of the second consecutive characters relative to the first consecutive characters; the counting control unit 300 calculates the recurrent count of the first consecutive characters; and the packet generating unit 304 determines the plurality of character data 22_2, the recurrent pattern data TYP and the recurrent count data NUM according to the first consecutive characters, the recurrent pattern and the recurrent count respectively, so as to generate the packet in the second encoding format 22. Accordingly, the padding data 22_3 may be filled with different recurrent patterns and recurrent count according to different data characteristics to further enhance the compression efficiency.

It should be noted that the character in the embodiments of the present invention is merely a unit of information, and the size of the character (the length of the character data N₂) is not limited to 4 bits or 8 bits as in the previous example. The character packing number M is not limited to 3, and those skilled in the art may adjust the appropriate character packing number M according to the characteristics of the original data.

Moreover, the length N₄ of the padding data 22_3 and the usage thereof do not limited to above embodiments, and should be adjusted and varied depending on the actual needs. For example, in an embodiment, the padding data 22_3 may be used to indicate the actual number of characters stored in the plurality of character data 22_2 of the second encoding format 22, but is not limited thereto. Specifically, please refer to the package 52 of the second encoding format 22 in FIG. 5, the plurality of character data 22_2 may be used to store up to 3 character data (the character packing number M equals 3). However, the package 52_5 actually stores only the characters “EF”. In this situation, the padding data 22_3 may be set as 2 (represented as “010” in binary) to record that package 52_5 carries 2 valid character data. Accordingly, during data decompression, the number of valid character data in the packet 52 of the second encoding format 22 may be determined from the padding data 22_3, which is particularly useful for determining the exact end of the original data. In another embodiment, the data compression circuit 30 may store the length information of the original data through a header data and store the header data together with the packets as the compressed data. Accordingly, when decompressing the data, the exact end of the original data may be determined from the header data.

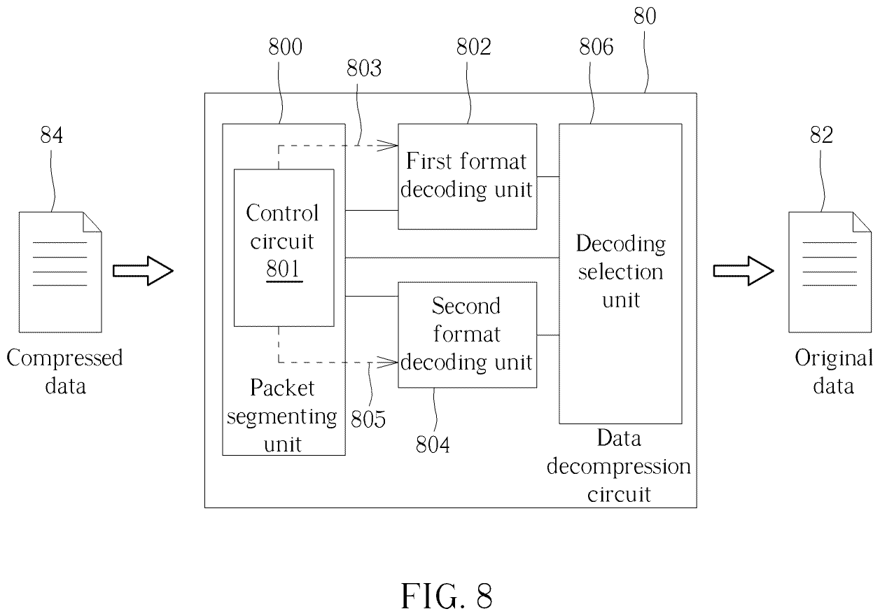

Please refer to FIG. 8, which is a schematic diagram of a data decompression circuit 80 according to an embodiment of the present invention. The data decompression circuit 80 may be used to decompress a compressed data 84 into an original data 82. The compressed data 84 is the compressed data that the original data 82 is compressed by the data compression circuit 30 according to the above data compression process 40, i.e., the original data 82 is compressed according to the encoding formats shown in FIG. 2. In other words, through the data decompression circuit 80 of the embodiment of the present invention, the compressed data 84 may be restored to the original data 82. The data decompression circuit 80 comprises a packet segmenting unit 800, a first format decoding unit 802, a second format decoding unit 804, and a decoding selection unit 806.

The packet segmenting unit 800 is coupled to the decoding selection unit 806, the first format decoding unit 802, and the second format decoding unit 804. The packet segmenting unit 800 is used to obtain the compressed data 84, segment the compressed data 84 into a plurality of packets in sequence, and obtain a flag carried in the packet. The first format decoding unit 802 is coupled to the packet segmenting unit 800 and the decoding selection unit 806, and is used to decode the packets from the packet segmenting unit 800 according to the first encoding format 21 and then transmit the packets to the decoding selection unit 806. The second format decoding unit 804 is coupled to the packet segmenting unit 800 and the decoding selection unit 806, and is used to decode the packets from the packet segmenting unit 800 according to the second encoding format 22 and then transmit the packets to the decoding selection unit 806. The decoding selection unit 806 is coupled to the packet segmenting unit 800, the first format decoding unit 802, and the second format decoding unit 804, and is used to select whether to output decoded data from the first format decoding unit 802 or the second format decoding unit 804 according to the flag transmitted from the packet segmenting unit 800.

In an embodiment, the data decompression circuit 80 may additional comprise a storage unit (not shown in FIG. 8). The storage unit is coupled to the packet segmenting unit 800 and is used for storing the compressed data 84. In another embodiment, the storage unit may be deployed outside of the data decompression circuit 80. It should be noted that in one implementation, the data transmission width (number of data bits) of the storage unit for storing the compressed data 84 may be equal to the packet length S. In this situation, a piece of data received from the storage unit is a packet, in other words, the packet segmenting unit 800 does not need to additionally segment the data according to the packet length S.

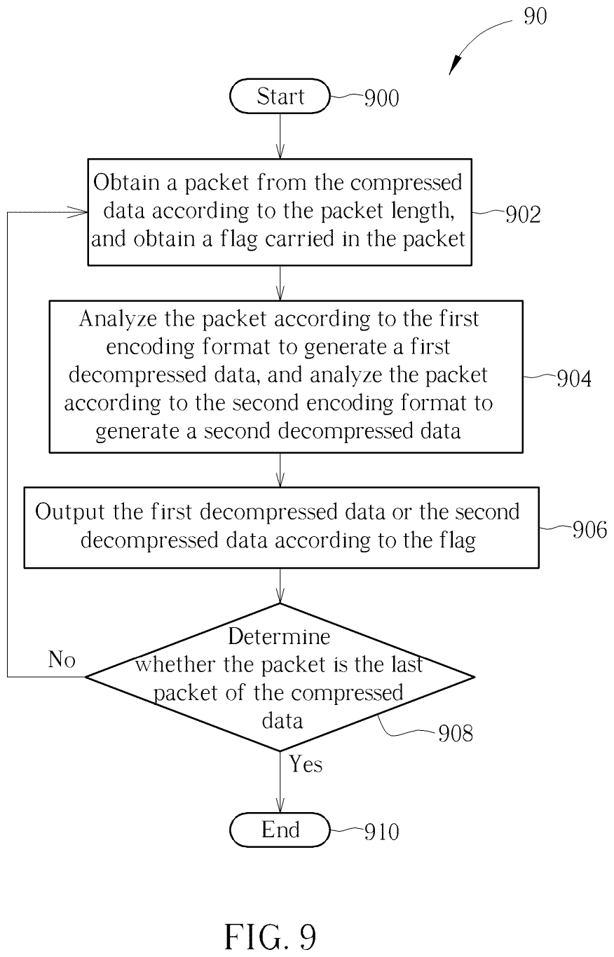

Please refer to FIG. 9, which is a flowchart of a data decompression process 90 according to an embodiment of the present invention. For illustrative purposes, the data decompression process 90 is described below in conjunction with the data decompression circuit 80 of FIG. 8. However, it should be understood that the data decompression process 90 may be executed by the data decompression circuit 80, but is not limited thereto. According to the data decompression process 90, the data decompression circuit 80 may decompress the compressed data 84 and then output and restore as the original data 82. The data decompression process 90 comprises the following steps:

Step 900: Start.

Step 902: Obtain a packet from the compressed data 84 according to the packet length S, and obtain a flag carried in the packet.

Step 904: Analyze the packet according to the first encoding format 21 to generate a first decompressed data, and analyze the packet according to the second encoding format 22 to generate a second decompressed data.

Step 906: Output the first decompressed data or the second decompressed data according to the flag.

Step 908: Determine whether the packet is the last packet of the compressed data 84. If yes, proceed to Step 910; otherwise, proceed to Step 902.

### Step 910: End.

In detail, in Step 900, the data decompression circuit 80 begins data decompression of the compressed data 84, which may comprise performing initialization settings of the data decompression circuit 80. The initialization settings may comprise and is not limited to setting the parameters of the first encoding format 21 and the second encoding format 22, such as the length of the flag data N₁, the length of the character data N₂, the length of the repeat count data N₃, the length of the padding data N₄, and the character packing number M.

In Step 902, the packet segmenting unit 800 obtains the packet from the compressed data 84 according to the packet length S and obtains the flag carried in the packet. Since the packets in the first encoding format 21 and the second encoding format 22 have the same length S in the embodiments of the present invention, the packet segmenting unit 800 is able to quickly segment the compressed data 84 into packets based on a fixed packet length. In one embodiment, the packet length S may be default information preset in the compression circuit and the decompression circuit. In another embodiment, the packet length S may be obtained from the aforementioned header data. Taking FIG. 5 as an example, the packet length of the packet 51 in the first encoding format 21 and the packet 52 in the second encoding format 22 are both 16 bits, and the packet segmenting unit 800 may segment a compressed data into the packets in unit of 16-bit. According to the packet formats of the first encoding format 21 and the second encoding format 22, the packet segmenting unit 800 may obtain the flag carried by each packet. For example, in the case of the packet 51 and the packet 52 in FIG. 5, the packet segmenting unit 800 may obtain the flag at the first bit of the packet, where the flag indicates whether the packet is generated according to the first encoding format 21 or the second encoding format 22. After obtaining the flag, the packet segmenting unit 800 transmits the flag to the decoding selection unit 806 and transmits the packet to the first format decoding unit 802 and the second format decoding unit 804.

In Step 904, the first format decoding unit 802 parses the packet according to the first encoding format 21 to generate the first decompressed data. At the same time, the second format decoding unit 804 parses the packet according to the second encoding format 22 to generate the second decompressed data. Specifically, according to the first encoding format 21, the first format decoding unit 802 firstly obtains a repeat character of the repeat character data 21_2 and a repeat count of the repeat count data 21_3. Then, the first format decoding unit 802 generates the first decompressed data according to the repeat character and the repeat count, and outputs the first decompressed data to the decoding selection unit 806. According to the second encoding format 22, the second format decoding unit 804 firstly obtains a plurality of character data 22_2, where the plurality of character data 22_2 comprises consecutive characters. Then, the second format decoding unit 804 generates the second decompressed data according to the consecutive characters of the plurality of character data 22_2, and outputs the second decompressed data to the decoding selection unit 806.

In another embodiment, Step 904 further comprises the second format decoding unit 804 analyzing the information of the padding data 22_3. Specifically, the second format decoding unit 804 analyzes the padding data 22_3 to obtain a recurrent pattern of the recurrent pattern data TYP and a recurrent count of the recurrent count data NUM, and then generates the second decompressed data according to the recurrent pattern and the recurrent count.

In Step 906, the decoding selection unit 806 determines to output the first decompressed data or the second decompressed data according to the flag sent by the packet segmenting unit 800. Specifically, each packet of the compressed data 84 is decoded according to the first encoding format 21 and the second encoding format 22 respectively, and the decoding selection unit 806 selects the corresponding data according to the flag and outputs as decompressed data.

Finally, in Step 908, the packet segmenting unit 800 determines whether the packet is the last packet of the compressed data 84. If not, return to Step 902 to process the next packet; if yes, the decompression of the compressed data 84 is completed in Step 910.

Accordingly, the data decompression circuit 80 may decompress the compressed data 84 and then output and restore as the original data 82.

In an embodiment, in Step 902, after obtaining the flag of the packet, the packet segmenting unit 800 may only transmit the remaining part of the packet to the first format decoding unit 802 and the second format decoding unit 804. Specifically, when the packet is in the first encoding format 21, the packet segmenting unit 800 may only transmit the repeat character data 21_2 and the repeat count data 21_3 to the first format decoding unit 802. When the packet is in the second encoding format 22, the packet segmenting unit 800 may only transmit the plurality of character data 22_2 and the padding data 22_3 to the second format decoding unit 804. According to the embodiment, the amount of data transmitted from the packet segmenting unit 800 to the first format decoding unit 802 and the second format decoding unit 804 may be reduced.

In an embodiment, the packet segmenting unit 800 further comprises a control circuit 801. In Step 902, the control circuit 801 may enable or disable the first format decoding unit 802 through a first driving signal 803, and enable or disable the second format decoding unit 804 through a second driving signal 805. When the flag indicates that the packet is generated according to the first encoding format 21, the control circuit 801 enables the first format decoding unit 802 to decode the packet of the first encoding format 21 through the first driving signal 803; at the same time, the control circuit 801 disables the second format decoding unit 804 through the second driving signal 805. When the flag indicates that the packet is generated according to the second encoding format 22, the control circuit 801 disables the first format decoding unit 802 through the first driving signal 803; at the same time, the control circuit 801 enables the second format decoding unit 804 to decode the packet of the second decoding format 22 through the second driving signal 805. According to the embodiment, only one of the first format decoding unit 802 and the second format decoding unit 804 decodes the packet, thereby further reducing the power consumption of the data decompression circuit 80.

It should be noted, the data compression method and data decompression method proposed in the present invention are corresponding technologies based on the same encoding formats (the first encoding format 21 and the second encoding format 22). In other words, the compressed data encoded by the data compression process 40 according to the first encoding format 21 and the second encoding format 22 may be decompressed and restored through the data decompression process 90 according to the first encoding format 21 and the second encoding format 22. Similarly, the compressed data encoded by the data compression circuit 30 according to the first encoding format 21 and the second encoding format 22 may be decompressed and restored through the data decompression circuit 80 according to the first encoding format 21 and the second encoding format 22. That is to say, the compressed data 34 in FIG. 3 may be decompressed and restored to the original data 32 in FIG. 3 through the data decompression circuit 80 in FIG. 8. The compressed data 84 in FIG. 8 may be compressed data compressed from the original data 82 through the data compression circuit 30 in FIG. 3.

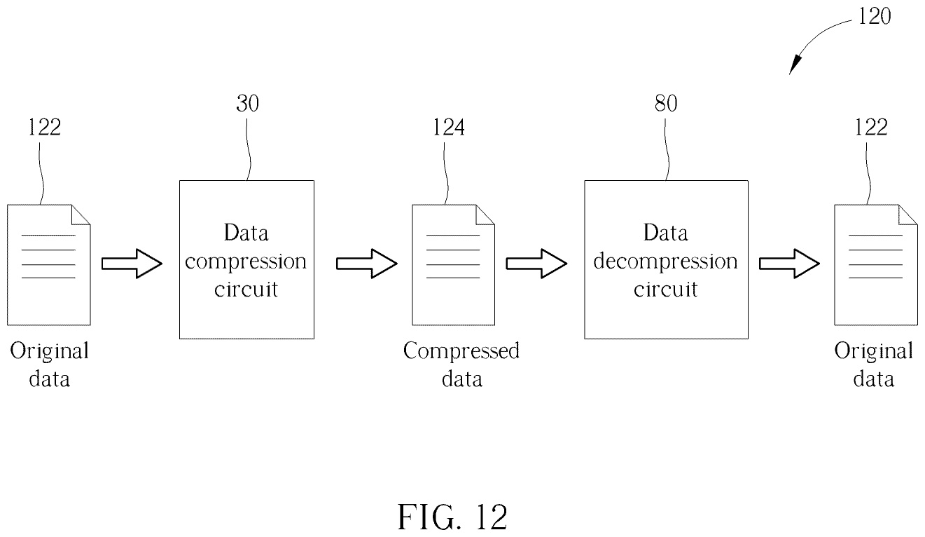

Please refer to FIG. 12, which is a schematic diagram of a data processing system 120 according to an embodiment of the present invention. The data processing system 120 comprises the data compression circuit 30 and the data decompression circuit 80. According to the first encoding format 21 and the second encoding format 22, the data compression circuit 30 may encode and compress an original data 122 into a compressed data 124. Accordingly, the effects of saving storage space, speeding up transmission and saving costs may be achieved. Similarly, according to the first encoding format 21 and the second encoding format 22, the data decompression circuit 80 may decompress the compressed data 124 and restore it to the original data 122. Note that, the original data 122 before data compression (as shown on the left side of FIG. 12) is exactly the same as the original data 122 after data compression and data decompression (as shown on the right side of FIG. 12). In other words, the data compression method according to the embodiment of the present invention is a lossless data compression method.

Please refer to FIG. 12 again, where the compressed data 124 shown in the FIG. 12 may be stored in a storage unit (not shown in FIG. 12). In different embodiments, the storage unit may be deployed within the data compression circuit 30 or within the data decompression circuit 80, or may be deployed independently outside the data compression circuit 30 and the data decompression circuit 80. The type and arrangement of the storage unit (including the storage units in the foregoing embodiments) may be determined according to actual application requirements. For example, the storage unit may be a memory device such as a flash memory, a random access memory (RAM), a hard disk, and a non-volatile storage unit, but is not limited thereto.

The data compression method and the data decompression method of the embodiment of the present invention are applicable for various types of data, including but not limited to text and images. Furthermore, in an embodiment, the original data of the embodiment of the present invention may be an image data, and the image data may be used for display of an instant on logo. The images for instant on logo are generally simple in terms of lines, shapes, and colors, and pixel contents thereof consists of a large amount of consecutive repetitions and a small amount of non-repetition. Traditional run-length encoding is suitable for the large amount of consecutive repetitions, but it is not good for the non-repetition. In comparison, the data compression method and the data decompression method in the embodiments of the present invention are not only suitable for the large amount of consecutive repetitions, but also suitable for the non-repetition data. Therefore, the data compression method and the data decompression method of the embodiment of the present invention are particularly suitable for application in the display of instant on logo.

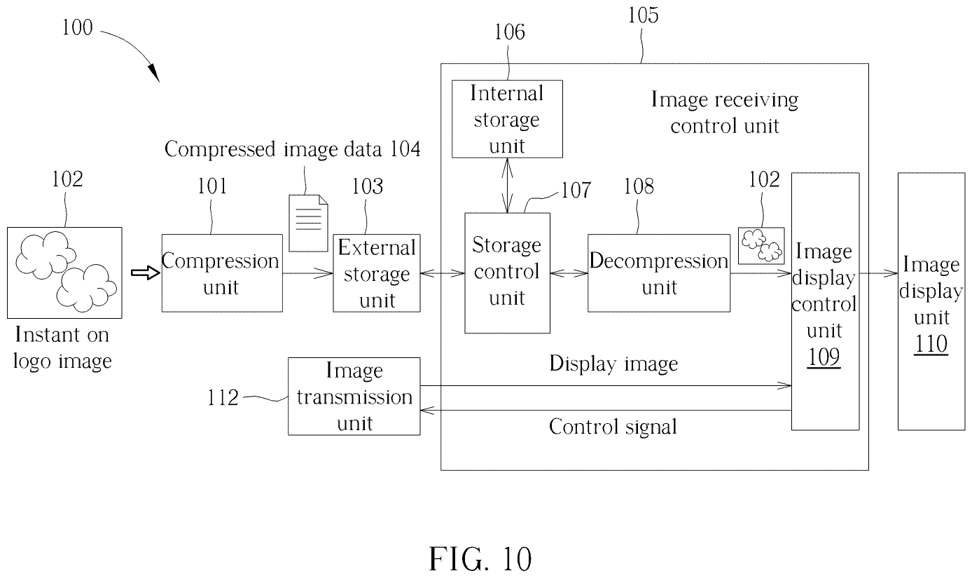

Please refer to FIG. 10, which is a schematic diagram of a data processing system 100 according to an embodiment of the present invention. The data processing system 100 may be any types of electronic devices containing a display, such as computers, cellphones, televisions, game consoles, cameras, electronic readers, in-vehicle display systems, and the like, and is not limited thereto. The data processing system 100 may decompress a compressed image data 104 stored in the system into an instant on logo image 102 at system startup and then display the image as a splash screen, where the instant on logo image 102 may be a static image or a dynamic video. The compressed image data 104 is a compressed data of the instant on logo image 102 compressed according to the above data compression process 40.

The data processing system 100 comprises an external storage unit 103, an image transmission unit 112, an image receiving control unit 105, and an image display unit 110. The image receiving control unit 105 may be a timing controller (TCON) that receives image data, processes the image data, and performs display control of the image display unit 110. Specifically, the image receiving control unit 105 comprises an internal storage unit 106, a storage control unit 107, a decompression unit 108, and an image display control unit 109. It should be noted that the data processing system 100 is only used to represent the necessary components to realize the embodiment of the present invention. Those with ordinary skill in the art may make different modifications and adjustments accordingly, and is not limited thereto.

The external storage unit 103 is coupled to the storage control unit 107 for storing the compressed image data 104. The external storage unit 103 may be any data storage device. For example, the external storage unit 103 may be but is not limited to a read-only memory (ROM), flash memory, random access memory (RAM), hard disk, optical data storage device, and non-volatile storage unit. The internal storage unit 106 is coupled to the storage control unit 107, and may be but is not limited to a frame buffer or cache memory for storing the compressed image data 104. Compared with the external storage unit 103, the internal storage unit 106 is able to provide a higher access speed. The internal storage unit 106 may be any internal storage device applicable to the SOC chip. For example, the internal storage unit 106 may be a static random access memory (SRAM), dynamic random access memory (DRAM), etc., and is not limited thereto. In the embodiment of the present invention, the external storage unit 103 and the internal storage unit 106 are collectively referred to as a storage unit. The storage control unit 107 is coupled to the storage unit and the decompression unit 108, and is used to read the compressed image data 104 stored in the storage unit and then transmit the compressed image data 104 to the decompression unit 108.

The decompression unit 108 is coupled to the storage control unit 107 and the image display control unit 109, and may be configured as the data decompression circuit 80. The decompression unit 108 is used to restore the instant on logo image 102 from the compressed image data 104 according to the data decompression process 90, and then output the instant on logo image 102 to the image display control unit 109.

The image transmission unit 112 is coupled to the image receiving control unit 105. As a graphics unit of the data processing system 100, the image transmission unit 112 may be but is not limited to a graphics processing unit (GPU). The image transmission unit 112 sends the display image of the data processing system 100 to the image display control unit 109, and provides a control signal to instruct the image display control unit 109 to output the instant on logo image 102 of the decompression unit 108 or the display image of the image transmission unit 112.

The image display control unit 109 is coupled to the decompression unit 108, the image transmission unit 112, and the image display unit 110, and is used for receiving and processing images, and performing display control of the image display unit 110. The image display control unit 109 further selects to output the instant on logo image 102 of the decompression unit 108 or the display image of the image transmission unit 112 to the image display unit 110 according to the control signal of the image transmission unit 112.

The image display unit 110 is coupled to the image display control unit 109, and may be a display panel for displaying images output from the image display control unit 109. For example, the image display unit 110 may be a liquid crystal display (LCD) panel, an organic light emitting diode (OLED) panel, or the like, but is not limited thereto.

Specifically, during the boot process of the data processing system 100, the image transmission unit 112 have to firstly carry out initial control settings (such as link training for display port), and only after the initialization is completed can it start sending display images to the image display control unit 109. Before sending display images, the image transmission unit 112 may instruct the image display control unit 109 to output the instant on logo image 102 to the image display unit 110 based on the control signal, allowing the user to confirm the status of the data processing system 100 as soon as possible. After the initialization is completed, the image transmission unit 112 may instruct the image display control unit 109 to switch to output the display image of the image transmission unit 112 to the image display unit 110 based on the control signal. Accordingly, it's possible to prevent from the problem of the image display unit 110 having no images to be displayed after the data processing system 100 boots up and before the image transmission unit 112 completes the initialization.

In an embodiment, the data processing system 100 further comprises a compression unit 101. The compression unit 101 is coupled to the external storage unit 103 and may be configured as the above-mentioned data compression circuit 30. The compression unit 101 compresses the instant on logo image 102 into the compressed image data 104 according to the data compression process 40 and then outputs the compressed image data 104. In this situation, the user may use the compression unit 101 to compress the user-defined instant on logo image 102 (splash screen) into the compressed image data 104 and store in the external storage unit 103. When the data processing system 100 is booted, the storage control unit 107 reads the compressed image data 104 from the external storage unit 103 and then stores the compressed image data 104 in the internal storage unit 106 or directly transmits the compressed image data 104 to the decompression unit 108. After obtaining the compressed image data 104 stored in the external storage unit 103 or in the internal storage unit 106 through the storage control unit 107, the decompression unit 108 restores the compressed image data 104 to the user-defined instant on logo image 102 according to the data decompression process 90. Finally, according to the control of the image transmission unit 112, the image display control unit 109 outputs the user-defined instant on logo image 102 to the image display unit 110 for display. In this situation, the compressed image data 104 may be obtained without using additional devices for data compression.

By compressing the instant on logo image 102 into the compressed image data 104, the storage space required to store the instant on logo image 102 may be significantly reduced, thus achieving the effect of reducing chip area and cost. In addition, after the instant on logo image 102 is compressed, the amount of data that needs to be read is also reduced, thereby reducing data access time and saving internal transmission resources, having the advantage of reducing power consumption.

In an embodiment, the compressed data (the compressed data 34, 84, 124, and the compressed image data 104) may additionally comprises a header data that may contain information related to the original data (the original data 32, 82, 122, and the instant on logo image 102) and encoding information. The information related to the original data may be and is not limited to information such as the length of the data, the length and width of the image. The information related to the encoding information may be and is not limited to information such as the length of the character data N₂, the length of the repeat count data N₃, the length of the padding data N₄.

Please refer to Table 1, which is an example of a header data format applicable to the data processing system 100. The field of “Number of data” is used to indicate the total amount of data in the compressed image data 104 (the unit of the number may be, for example, “bytes”), and fields of “Width” and “Height” are used to indicate the image width and image height of the instant on logo image 102 (i.e., the width and height of the display screen) respectively. The fields of “Length of character data”, “Length of repeat count data” and “Length of padding data” are used to indicate the length of the repeat character data 21_2 (namely, the length N₂ of the character data), the length N₃ of the repeat count data 21_3, and the length N₄ of the padding data 22_3 in the compression format used by the compressed image data 104 respectively. The checksum is used to check whether the transmitted data is correct. The field of “Checksum for compressed data” is used to record a checksum of the compressed data (composed of packets generated according to the first encoding format 21 and the second encoding format 22), and the field of “Checksum for header data” is used to record a checksum of the header data (excluding the checksum for header data). According to the header data as shown in Table 1, the compression unit 101 may generate and store the header data to record the information of the instant on logo image 102 and the compression parameters used for the compressed image data 104. According to the header data generated by the compression unit 101, the decompression unit 108 may obtain the information about the original instant on logo image 102 and the compression parameters used in the compressed image data 104, and thereby decompress the compressed image data 104 to restore the instant on logo image 102 based on the information. Accordingly, the image display control unit 109 may correctly display the instant on logo image 102 on the image display unit 110. In addition, the header data may replace the aforementioned method of recording the number of valid character data carried in the plurality of character data 22_2 of the second encoding format 22 through padding data 22_3, which is able to handle the case where the number of the remaining characters in the original data 50 of FIG. 5 is insufficient for character packing number (the character packing number M is 3, but packet 52_5 actually only carries two characters “EF”).

TABLE 1

| Field name | Field length (bits) |
|---|---|
| Number of data | 24 |
| Width | 16 |
| Height | 16 |
| Length of character data (N₂) | 8 |
| Length of repeat count data (N₃) | 8 |
| Length of padding data (N₄) | 8 |
| Checksum for compressed data | 8 |
| Checksum for header data | 8 |

It should be noted, in this embodiment, the original data number of the instant on logo image 102 may be derived from the fields of “Width”, “Height” and “Length of character data” listed in Table 1. However, when the header data is used for an original data of non-image, an additional “Number of original data” field may be added in place of the fields of “Width” and “Height”, so that the compression unit may be the field to indicate the number of data contained in the original data before compression.

In an embodiment, the data processing system 100 may select one of a plurality of instant on logo images to be displayed during booting process. In this case, the external storage unit 103 may store a plurality of compressed image data corresponding to the plurality of instant on logo images, and the image receiving control unit 105 may display the designated instant on logo image according to an index value through a front-end command. Please refer to Table 2, which is a storage arrangement for storing Num_{L} compressed image data of the instant on logo images in the external storage unit 103 according to the embodiment of the present invention, where each row represents a valid data segment. The compressed data Cmpᵢ represents the compressed image data corresponding to the instant on logo image with index value i, and the header data Hdrᵢ represents the header data thereof. The image receiving control unit 105 may obtain the size of the compressed data Cmpᵢ according to the header data Hdrᵢ, accordingly obtain the compressed image data corresponding to the instant on logo image to be displayed according to the index value, and display the instant on logo image on the image display unit 110 after decompression.

TABLE 2

Header data Hdr₀
Compressed data Cmp₀
Header data Hdr₁
Compressed data Cmp₁
. . .
Header data Hdr_{Num}_{_{L}}₋₁
Compressed data Cmp_{Num}_{_{L}}₋₁

Although the data processing system 100 mentioned above is used for display of the instant on logo images, the combination of the compression unit 101 and the decompression unit 108 is not limited to the compression and decompression thereof. Through the compression unit 101, various types of data may be compressed to reduce the amount of data without loss and save the resources of internal access and transmission of the system so as to improve the efficiency; through the decompression unit 108, the compressed data may be restored for subsequent processing.

Please refer to FIG. 11, which shows different compression parameters of three compression examples according to an embodiment of the present invention. As shown in FIG. 11, the resolution of an original image 111 is 903×333, the color depth is 4 bits per pixel, and the size of the original image 111 is 150350 bytes. It should be noted that the actual image of the original image 111 is a color image, and FIG. 11 only uses line halftones with varying density to represent the different colors of the original image 111.

Please also refer to Table 3, which shows the results of compressing the original image 111 according to three different packet lengths S in the embodiment. According to the case (A), the packet A1 of the first encoding format 21 and the packet A2 of the second encoding format 22 are used for compression. The length N₂ of the character data is 4 bits (in this embodiment, N₂ is set equal to the color depth), the character packing number M is 2, and the packet length S is 12 bits. After compression, the size of the compressed original image 111 is 12202 bytes, with a compression rate of 8.11%. According to the case (B), the packet B1 of the first encoding format 21 and the packet B2 of the second encoding format 22 are used for compression. The length N₂ of the character data is 4 bits, the character packing number M is 3, and the packet length S is 16 bits. After compression, the size of the compressed original image 111 is 12950 bytes, with a compression rate of 8.61%. According to the case (C), the packet C1 of the first encoding format 21 and the packet C2 of the second encoding format 22 are used for compression. The length N₂ of the character data is 4 bits, the character packing number M is 4, and the packet length S is 20 bits. After compression, the size of the compressed original image 111 is 15842 bytes, with a compression rate of 10.53%. As can be seen, the compression method according to the present invention achieves an excellent compression rate.

| Case | Size (bytes) | Compression rate (%) |
|---|---|---|
| The original image | 150350 | |
| (A) S = 12 | 12202 | 8.11 |
| (B) S = 16 | 12950 | 8.61 |
| (C) S = 20 | 15842 | 10.53 |

In summary, the present invention proposes a lossless data compression method, a data compression circuit, a data decompression method and a data decompression circuit, which are capable of simultaneously taking into account both repetitive and non-repetitive data, greatly improving the data compression rate and thus reducing the storage space requirement. On the other hand, the present invention proposes a data processing system that utilizes the aforementioned data compression method and data decompression method in instant on logo display technology, which reduces the storage space required for storing the instant on logo images and significantly reduces costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data compression method, used for an original data containing a plurality of characters, comprising:
(a) sequentially obtaining first consecutive characters from the original data, wherein a number of characters of the first consecutive characters is a character packing number;
(b) comparing whether each character of the first consecutive characters is the same to obtain a comparison result;
(c) generating a packet in a first encoding format when the comparison result indicates that the first consecutive characters are repetitions of a repeat character, or generating the packet in a second encoding format when the comparison result indicates that the first consecutive characters comprise different characters; and
(d) outputting the packet;
wherein the packet in the first encoding format and the packet in the second encoding format have the same length.

2. The data compression method of claim 1, wherein the first encoding format comprises:
a first flag data, used to indicate that the packet is generated based on the first encoding format according to a first flag;
a repeat character data, used to indicate the repeat character of the first consecutive characters; and
a repeat count data, used to indicate a repeat count of the repeat character;
wherein the second encoding format comprises:
a second flag data, used to indicate that the packet is generated based on the second encoding format according to a second flag; and
a plurality of character data, used to indicate the first consecutive characters, wherein a number of the plurality of character data is equal to the character packing number.

3. The data compression method of claim 2, wherein generating the packet in the first encoding format in the step (c) comprises:
obtaining and calculating the repeat count of the repeat character in consecutive characters starting with the first consecutive characters in the original data; and
determining the first flag data, the repeat character data and the repeat count data according to the first flag, the repeat character and the repeat count respectively, so as to generate the packet in the first encoding format;
wherein generating the packet in the second encoding format in the step (c) comprises:
determining the second flag data and the plurality of character data according to the second flag and the first consecutive characters respectively, so as to generate the packet in the second encoding format.

4. The data compression method of claim 3, wherein the second encoding format further comprises a padding data;
wherein generating the packet in the second encoding format in the step (c) further comprises:
setting the padding data as dummy bits.

5. The data compression method of claim 4, wherein the padding data comprises:
a recurrent pattern data, used to indicate a recurrent pattern of the first consecutive characters; and
a recurrent count data, used to indicate a recurrent count of the first consecutive characters;
wherein the recurrent pattern comprises non-recurrent, recurrent, inversion and mirroring information of the first consecutive characters.

6. The data compression method of claim 5, wherein generating the packet in the second encoding format in the step (c) further comprises:
obtaining a second consecutive characters following the first consecutive characters in the original data;
determining the recurrent pattern of the second consecutive characters relative to the first consecutive characters;
calculating the recurrent count of the first consecutive characters; and
determining the plurality of character data, the recurrent pattern data and the recurrent count data according to the first consecutive characters, the recurrent pattern and the recurrent count respectively, so as to generate the packet in the second encoding format.

7. The data compression method of claim 1, wherein the original data is an image data, and the image data is used for instant on logo display.

8. A data compression circuit, used for an original data containing a plurality of characters, comprising:
a counting control unit, used to sequentially obtain first consecutive characters from the original data, wherein a number of characters of the first consecutive characters is a character packing number;
a data comparing unit, coupled to the counting control unit, used to compare whether each character of the first consecutive characters is the same to obtain a comparison result;
a packet generating unit, coupled to the counting control unit and the data comparing unit, used to generate a packet in a first encoding format when the comparison result indicates that the first consecutive characters are repetitions of a repeat character or generate the packet in a second encoding format when the comparison result indicates that the first consecutive characters comprise different characters, and output the packet;
wherein the packet in the first encoding format and the packet in the second encoding format have the same length.

9. The data compression circuit of claim 8, wherein the first encoding format comprises:
a first flag data, used to indicate that the packet is generated based on the first encoding format according to a first flag;
a repeat character data, used to indicate the repeat character of the first consecutive characters; and
a repeat count data, used to indicate a repeat count of the repeat character;
wherein the second encoding format comprises:
a second flag data, used to indicate that the packet is generated based on the second encoding format according to a second flag; and
a plurality of character data, used to indicate the first consecutive characters, wherein a number of the plurality of character data is equal to the character packing number.

10. The data compression circuit of claim 9, wherein the function of generating the packet in the first encoding format comprises:
obtaining, by the counting control unit, and calculating the repeat count of the repeat character in consecutive characters starting with the first consecutive characters in the original data; and
determining, by the packet generating unit, the first flag data, the repeat character data and the repeat count data according to the first flag, the repeat character and the repeat count respectively, so as to generate the packet in the first encoding format;
wherein the function of generating the packet in the second encoding format comprises:
determining, by the packet generating unit, the second flag data and the plurality of character data according to the second flag and the first consecutive characters respectively, so as to generate the packet in the second encoding format.

11. The data compression circuit of claim 10, wherein the second encoding format further comprises a padding data;
wherein the function of generating the packet in the second encoding format further comprises:
setting, by the packet generating unit, the padding data as dummy bits.

12. The data compression circuit of claim 11, wherein the padding data comprises:
a recurrent pattern data, used to indicate a recurrent pattern of the first consecutive characters; and
a recurrent count data, used to indicate a recurrent count of the first consecutive characters;
wherein the recurrent pattern comprises non-recurrent, recurrent, inversion and mirroring information of the first consecutive characters.

13. The data compression circuit of claim 12, wherein the function of generating the packet in the second encoding format further comprises:
obtaining, by the counting control unit, a second consecutive characters following the first consecutive characters in the original data;
determining, by the data comparing unit, the recurrent pattern of the second consecutive characters relative to the first consecutive characters;
calculating, by the counting control unit, the recurrent count of the first consecutive characters; and
determining, by the packet generating unit, the plurality of character data, the recurrent pattern data and the recurrent count data according to the first consecutive characters, the recurrent pattern and the recurrent count respectively, so as to generate the packet in the second encoding format.

14. The data compression circuit of claim 8, wherein the original data is an image data, and the image data is used for instant on logo display.

15. A data decompression method, comprising:
obtaining a packet from a compressed data according to a packet length, and obtaining a flag carried in the packet;
analyzing the packet according to a first encoding format to generate a first decompressed data, and analyzing the packet according to a second encoding format to generate a second decompressed data; and
outputting the first decompressed data or the second decompressed data according to the flag.

16. The data decompression method of claim 15, wherein the first encoding format comprises:
a first flag data, comprising the flag, used to indicate that the packet is generated based on the first encoding format according to the flag;
a repeat character data, used to indicate a repeat character; and
a repeat count data, used to indicate a repeat count of the repeat character;
wherein the second encoding format comprises:
a second flag data, comprising the flag, used to indicate that the packet is generated based on the second encoding format according to the flag; and
a plurality of character data, used to indicate a consecutive characters.

17. The data decompression method of claim 16, wherein the step of analyzing the packet according to the first encoding format to generate the first decompressed data comprises:
generating the first decompressed data according to the repeat character and the repeat count;
wherein the step of analyzing the packet according to the second encoding format to generate the second decompressed data comprises:
generating the second decompressed data according to the consecutive characters.

18. The data decompression method of claim 17, wherein the second encoding format further comprises a padding data, and the data decompression method further comprises analyzing the following information of the padding data:
a recurrent pattern data, used to indicate a recurrent pattern of the consecutive characters; and
a recurrent count data, used to indicate a recurrent count of the consecutive characters;
wherein the recurrent pattern comprises non-recurrent, recurrent, inversion and mirroring information of the first consecutive characters;
wherein the step of analyzing the packet according to the second encoding format to generate the second decompressed data further comprises:
generating the second decompressed data according to the recurrent pattern and the recurrent count.

19. The data decompression method of claim 15, wherein the compressed data is a compression of an image data, and the image data is used for instant on logo display.

20. A data decompression circuit, comprising:
a packet segmenting unit, used to obtain a packet from a compressed data according to a packet length, and obtain a flag carried in the packet;
a first format decoding unit, coupled to the packet segmenting unit, used to analyze the packet according to a first encoding format to generate a first decompressed data;
a second format decoding unit, coupled to the packet segmenting unit, used to analyze the packet according to a second encoding format to generate a second decompressed data; and
a decoding selection unit, coupled to the packet segmenting unit, the first format decoding unit and the second format decoding unit, used to output the first decompressed data or the second decompressed data according to the flag.

21. The data decompression circuit of claim 20, wherein the first encoding format comprises:
a first flag data, comprising the flag, used to indicate that the packet is generated based on the first encoding format according to the flag;
a repeat character data, used to indicate a repeat character; and
a repeat count data, used to indicate a repeat count of the repeat character;
wherein the second encoding format comprises:
a second flag data, comprising the flag, used to indicate that the packet is generated based on the second encoding format according to the flag; and
a plurality of character data, used to indicate a consecutive characters.

22. The data decompression circuit of claim 21, wherein the function of analyzing the packet according to the first encoding format to generate the first decompressed data comprises:
generating the first decompressed data according to the repeat character and the repeat count;
wherein the function of analyzing the packet according to the second encoding format to generate the second decompressed data comprises:
generating the second decompressed data according to the consecutive characters.

23. The data decompression circuit of claim 22, wherein the second encoding format further comprises a padding data, and the second format decoding unit further analyzes the following information of the padding data:
a recurrent pattern data, used to indicate a recurrent pattern of the consecutive characters; and
a recurrent count data, used to indicate a recurrent count of the consecutive characters;
wherein the recurrent pattern comprises non-recurrent, recurrent, inversion and mirroring information of the first consecutive characters;
wherein the function of the second format decoding unit analyzing the packet according to the second encoding format to generate the second decompressed data further comprises:
generating the second decompressed data according to the recurrent pattern and the recurrent count.

24. The data decompression circuit of claim 20, wherein the compressed data is a compression of an image data, and the image data is used for instant on logo display.

25. A data processing system, comprising:
a storage unit, used to store a compressed image data;
a storage control unit, coupled to the storage unit, used to read the compressed image data;
a decompression unit, coupled to the storage control unit, configured as the data decompression circuit of claim 20, used to decompress the compressed image data into an instant on logo image and output the instant on logo image; and
an image display control unit, coupled to the decompression unit and an image transmission unit, used to output the instant on logo image of the decompression unit or a display image of the image transmission unit to an image display unit according to a control signal of the image sending unit.

26. The data processing system of claim 25, further comprising a compression unit, wherein the compression unit is used to compress the instant on logo image into the compressed image data, and the compression unit comprises:
a counting control unit, used to sequentially obtain first consecutive characters from the instant on logo image, wherein a number of characters of the first consecutive characters is a character packing number;
a data comparing unit, coupled to the counting control unit, used to compare each character of the first consecutive characters to obtain a comparison result;
a packet generating unit, coupled to the counting control unit and the data comparing unit, used to generate a packet in a first encoding format when the comparison result indicates that the first consecutive characters are repetitions of a repeat character or generate the packet in a second encoding format when the comparison result indicates that the first consecutive characters comprise different characters, and output the packet;
wherein the packet in the first encoding format and the packet in the second encoding format have the same length;
wherein the packet generating units outputs the packet to the storage unit so as to store as the compressed image data.
